(19) United States
(12) Patent Application Publication
(10) Pub. No.: US 2018/0130613 A1
(43) Pub. Date: May 10, 2018

(54) Low Profile Deadman Switch

(71) Applicants: Phuong Taylor Nguyen, Richmond, TX (US); Jeffrey Wayne Hummel, Fresno, TX (US)

(72) Inventors: Phuong Taylor Nguyen, Richmond, TX (US); Jeffrey Wayne Hummel, Fresno, TX (US)

(21) Appl. No.: 14/705,471

(22) Filed: May 6, 2015

(51) Int. Cl. H01H 3/04; H01H 13/18; H01H 9/06; H01H 13/50; B24C 3/02; B24C 5/02; B25F 5/02

(52) U.S. Cl. CPC H01H 3/04; H01H 13/186; H01H 9/06; H01H 13/506; B24C 3/02; B05B 15/63; B25F 5/02; H01H 2300/026; H01H 2225/008; H01H 2300/028; B24C 5/02

(57) ABSTRACT

A deadman switch system includes a primary deadman switch actuator and a secondary deadman switch actuator for controlling the flow of an air/abrasive mix through a flow line of a delivery system. The secondary deadman switch is positioned in series with a primary deadman switch actuator such that the controlled flow will not function unless first the primary deadman switch and then the secondary switch are closed. The preferred embodiment of the switch is a low-profile configuration adapted to be mounted in axial alignment with the flow line in a manner to minimize interference with normal operation of the system. The switch can include multiple open/close elements, for selectively controlling different flow functions.

### BACKGROUND OF THE INVENTION

### Field of the Invention

The invention is generally directed to a remotely located manually operable control switch for operating blast systems and is specifically directed to a secondary deadman switch for use in combination with a primary deadman switch, both of which much be activated to permit operation of the system.

### Discussion of the Prior Art

Deadman valves or switches are generally well known, and are used in a wide variety of industrial applications to operate devices or to prevent the operation of such devices. In fact, the Occupational Health and Safety Organization (OSHA) requires a safety system on all abrasive blasting equipment as well as on other equipment. Such safety systems usually include what is referred to in the art as a “deadman control.” A deadman control is a device that stops the machinery when the control is released. As is well known, these controls have been implemented as mechanical, pneumatic and electric deadman controls. In general, these valves or switches require prolonged engagement or actuation by a user who for one reason or another has part of his or her attention distracted from operation of the switch. Specifically, the operator is often focused on the operation of the system and takes the operability of the switch for granted. The deadman control increases the safety of the operation by requiring that the switch be actively engaged in order for the system to be “on.”

The deadman switches are designed to function in a fail-safe mode wherein the switch is automatically in the off position when certain conditions are not met. Typically, the failure to apply operating stimulus to the switch results in an immediate signal to shutdown.

Such switches and valves are provided in many industrial applications such as blasting systems, power tools, industrial equipment and machinery and the like. The deadman switches are designed to prevent movement of the control device when the operator's attention is distracted from such a device. These switches permit operation of the device only when they are engaged and otherwise prevent the transmission of electrical, pneumatic, or hydraulic power to valves and other devices required to operate the machine.

The standard deadman switch comprises a simple push-button switch which is spring biased into its open position and which must be depressed into its actuated or closed position permitting operation of the device on which it is mounted. The typical switch is difficult to depress for extended periods of time because of fatigue.

One type of actuator for a deadman switch is the “mushroom” switch which requires less accurate positioning of the operator's hand. Another widely used configuration is the use of a control lever which is connected to the device on which the switch is mounted and which extends over the switch by a substantial distance and which may thus be more easily actuated. One such control lever is disclosed in U.S. Pat. No. 4,270,032, which issued to Dobberpuhl on May 26, 1981. The device is operated by deflecting the control lever against the biasing force of a return spring into contact with the switch, thus depressing and closing the switch and permitting operation of the machine. When the operator's hand is removed from the lever, the lever is returned to its initial position under the biasing force of the return spring, thus opening the switch and deactivating the device. Movement of the control lever in both directions is limited by a return stop.

An improvement in the pneumatic deadman control switch is shown and described in my co-pending application, U.S. Ser. No. 11/338,154 filed on Jan. 24, 2006, entitled: “Ergonomic Pneumatic Deadman Valve”. That switch incorporates an ergonomic design that decreases the fatigue factor encountered when using many of the prior art switches.

A prior art electric deadman switch is offered by Axxiom Manufacturing, Inc., the assignee of the subject application. While this switch meets many of the desired operational characteristics of a deadman control switch, it does not incorporate the desirable ergonomic features described in the aforementioned pending application, and it is cumbersome to manufacture, assemble and service.

Another deadman switch with good ergonomic features and the advantage of near immediate shut-off when disengaged is shown and described in U.S. Pat. No. 8,288,670.

### SUMMARY OF THE INVENTION

The subject invention is directed to a new and novel deadman control that incorporates a standard prior deadman switch as a primary switch and a second deadman switch in series with the primary switch, requiring that both the primary switch and the secondary switch be activated in order to actuate the system for operation.

This feature is particularly useful in system such as abrasive blasting systems where use of two handed operation is encouraged in order to protect both hands from injury during operation and to assure that the operator has both hands gripped on the system. The deadman control system of the subject invention requires both a primary and a secondary switch to be closed, or actuated, in order to power the system. The designation of primary and secondary is determined by the control circuitry depending on which switch is firs and which switch is second in a series wired control circuit. In the preferred embodiment the primary switch must be activated in order for the secondary switch to work. This primary switch is closest to the nozzle and ensures that the operator has secure control of the hose and nozzle before the system is activated by engaging the secondary switch.

The preferred embodiment of the invention includes a secondary deadman switch adapted for use in combination with a primary deadman switch. The primary switch must be on before the secondary switch can be enabled. The switch of the subject invention may be installed as new, original equipment or may be retrofitted to systems currently in operation.

The secondary deadman switch system of the invention includes a circuit open and a circuit closed actuator for controlling the flow of an air/abrasive mix through a flow line of a delivery system, and is adapted to be positioned in series with a primary deadman switch actuator such that the controlled flow will not function unless both the primary deadman switch and the secondary back-up switch are closed. The preferred embodiment of the secondary switch is a low-profile configuration adapted to be mounted in axial alignment with the flow line in a manner to minimize interference with normal operation of the system. The secondary switch is easier and more comfortable to operate than the primary switch which has a safety lock mechanism. The secondary switch can include multiple open/close elements, for selectively controlling different flow functions.

Labels may be provided on each of the multiple open/close elements for defining the control function of each element. It may be desirable to color code the labels for defining the various functions. In one useful configuration, one multiple element controls the flow of air through the system and another the elements controls the simultaneous flow of air and abrasive in a mix through the system.

The construction of the preferred embodiment includes at least one base element adapted to be placed directly on the flow conduit, a conductor in the base element for completing a switch circuit, an interrupt switch for opening and closing the switch circuit, wherein the circuit for controlling flow in the delivery system is not closed unless switch interrupt switch is closed.

An end cap is positioned on the end of the base element for securing the interrupt switch in the assembly once the assembly is mounted on the flow line. The base element has a contoured engagement surface conforming to the peripheral surface of the flow line, and a through slot for receiving a securement means adapted to be placed through the through slot and about the perimeter of the flow line for securing the base element to the flow line. One suitable securement means is an alligator tie.

In the preferred embodiment the primary switch is a typical deadman control switch such as that disclosed in the prior art. Where desirable, the primary switch may be a modular deadman control switch of an ergonomic design to provide enhanced user comfort as well as to improve design efficiency and ease of manufacture, such as that disclosed in my aforementioned U.S. Pat. No. 8,288,670. However, any well-known deadman switch in the art may be used without departing from the scope and spirit of the subject invention.

Also, in the preferred embodiment, both switches are typically electrically actuated. However, depending on application and preference one or both could be pneumatic.

Where desired, the secondary switch system may have multiple functions. For example, in a pressurized air/media blast system, the secondary switch system may have two independently operable switch units for controlling separate operating functions, for example: (1) actuation of both the air and media delivery, and (2) actuation of air only to purge the system of media materials.

It is an important feature of the invention that the secondary switch can be retrofitted on prior art systems and coupled to the primary switch circuitry to permit upgrading of currently operating systems to provide for required two hand operation.

It is also an important feature of the invention that both the primary switch and the secondary switch can be positioned to accommodate either left-hand or right-hand operation. In the preferred embodiment, the primary switch is positioned on the top of the delivery system and will readily accommodate operation by either hand. The secondary switch is on the side of the delivery system and can be positioned on either side depending on left-hand or right-hand preference. However, other placements of the secondary switch may be made without departing from the scope of the invention.

### BRIEF DESCRIPTION OF THE DRAWINGS

FIG. 1 is an illustration of the assembled system as held by an operator with his right hand on the primary switch and his left hand on the secondary switch.

FIG. 2 is an illustration of the dual primary switch and secondary switch assembly as positioned for installation on a delivery hose of delivery system.

FIG. 3 is an enlarged, partial view looking in the same direction as FIG. 2 showing the secondary switch assembly in greater detail.

FIG. 4 is an exploded view showing the components of a preferred embodiment of an assembly comprising both the primary switch and the secondary switch.

FIG. 5 is an enlarged, exploded view looking in the same direction as FIG. 4, showing the secondary switch assembly.

FIG. 6 is a diagram of an electric control circuit with a single function secondary switch.

FIG. 7 is a diagram of an electric control circuit with a dual function secondary switch.

### DETAILED DESCRIPTION

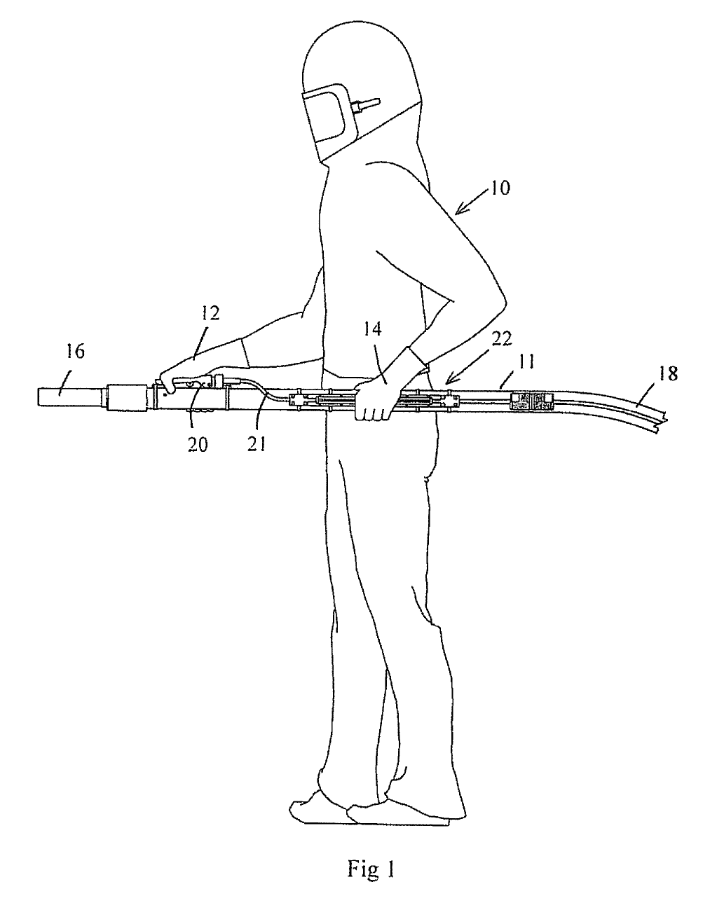

As shown in FIG. 1, an operator 10 will typically hold a delivery hose or similar conduit 11 with his right hand 12 and his left hand 14 positioned such that the nozzle 16 can be directed by movement of the left hand with the system primarily supported by the left hand and the right hand providing supplemental support. As is well known in the art, the opposite end 18 of the delivery hose is connected to a source of both media aggregate and pressurized air.

In the prior art, the right hand could be removed without interfering with the flow of media through the nozzle. This reduces control of the hose and nozzle combination. In the embodiment shown, the deadman control system comprises a primary switch 20 and a secondary switch 22. The switches are connected in series so that both must be actuated in order for the system to be powered. The primary switch 20 is typically a deadman switch configured in the same manner as those well known in the art, see for example, the aforementioned U.S. Pat. No. 8,288,670. In the preferred embodiment this switch 20 must be closed before the secondary switch 22 can be actuated or live.

The secondary switch 22 has a low profile, more ergonomic design and is positioned on the delivery hose in such a manner to minimize the difference in feel when compared to a prior art system without the secondary switch, minimizing retraining or repositioning by the operator.

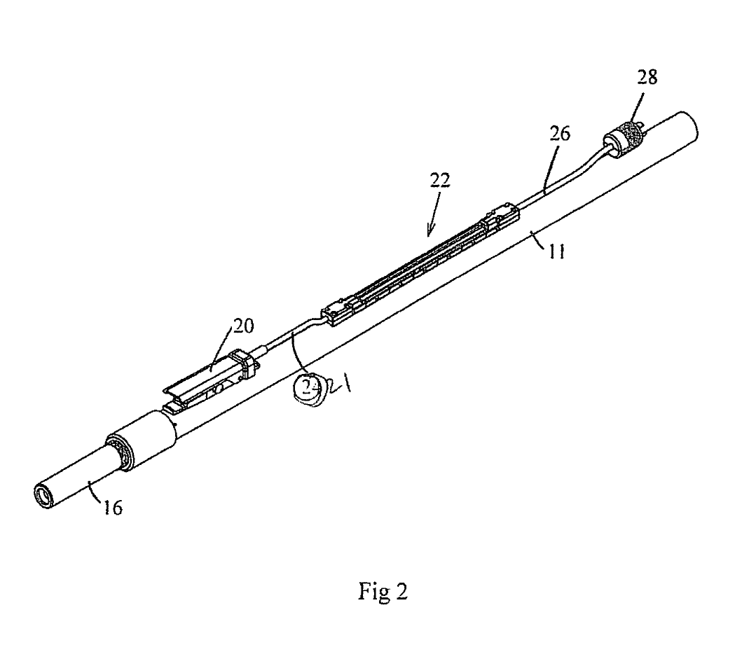

Turning to FIG. 2, when assembling the dual switch system of the present invention, the primary switch 20 is mounted on the hose or conduit 11 in typical manner and generally mounted close to the nozzle 16. The secondary switch 22 is mounted behind or upstream of the primary switch 20 and in a position normally consistent with the placement of the hand on the conduit during operation. Preferably the secondary switch is elongated to permit positioning of the hand in a variety of locations along the axis of the conduit to provide flexibility and maximum comfort for the operator.

The circuitry is provided by a conductor, in the embodiment an electrical wire 21, which is connected to a switch controlling the primary switch 20 and passing along the conduit to the secondary switch 22. The conductor is interrupted by an in-line switch circuit controlled by the secondary switch 22. This, then, requires that both switches be closed in order for the system to be under power.

The conductor proceeds through the second switch as shown at 26 to a suitable connector coupling 28, where the system is connected to an electrical or other power control system in typical manner.

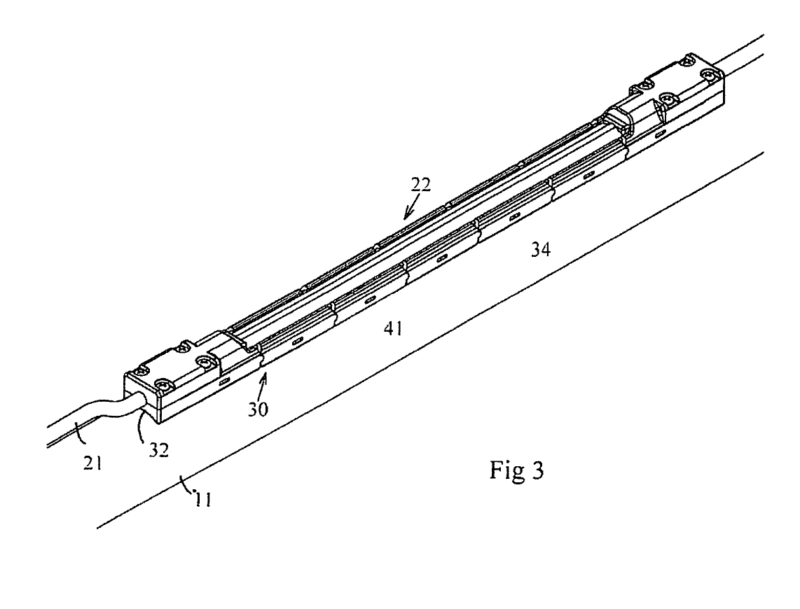

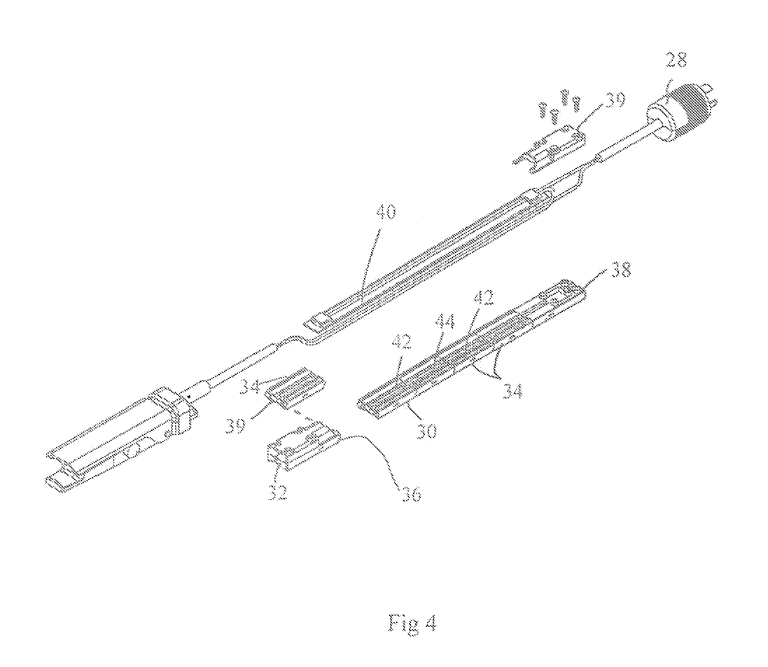

In the preferred embodiment the secondary switch 22 is of an elongated, low profile design. This permits variable gripping points and minimizes the change in feel to maximize the comfort of the operator. As shown in FIGS. 3, 4 and 5, switch 22 comprises a base 30 which has a concave curved lower surface 32 adapted to mate with the convex perimeter of the conduit 11. In the preferred embodiment the base 30 comprises a plurality of segments 34 with opposite end caps 36 and 38. The through slots 41 permit the secondary switch assembly to be secured to the conduit 11 by alligator ties (not shown) or the like. This permits easy installation and removal. The segmented configuration keeps the strip design secondary switch on the base. The segments can move with the base, permitting the switch assembly to bend with the supply hose in normal use, without excessively bending to break the connections.

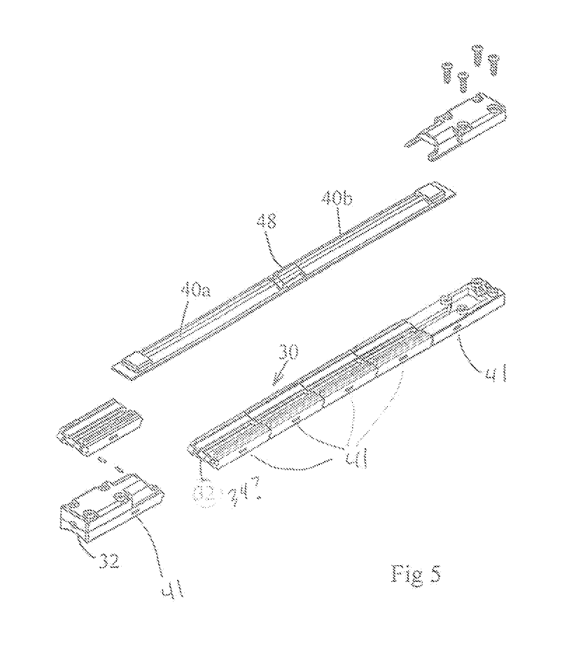

The active switch element 40 is a flexible strip member which can be depressed by the operator when gripping the conduit. The switch element 40 is depressed against a conductor pair 42 and 44 in each segment 30 to close the circuit between switch 20 and connector 28. Each of the endcaps 36 and 38 includes a cover 39 adapted for securing the switch element 40 in assembled relationship.

Where desired, and as shown in FIG. 5, the switch element 40 and be separated into multiple sections such as sections 40a and 40b, isolated by the insulator 48. This permits multiple operational configurations. For example, when segment 40a is engaged both air and media may be powered to flow through the conduit and nozzle. When segment 40b is engaged, only air may pass through the conduit to purge the line of media residue.

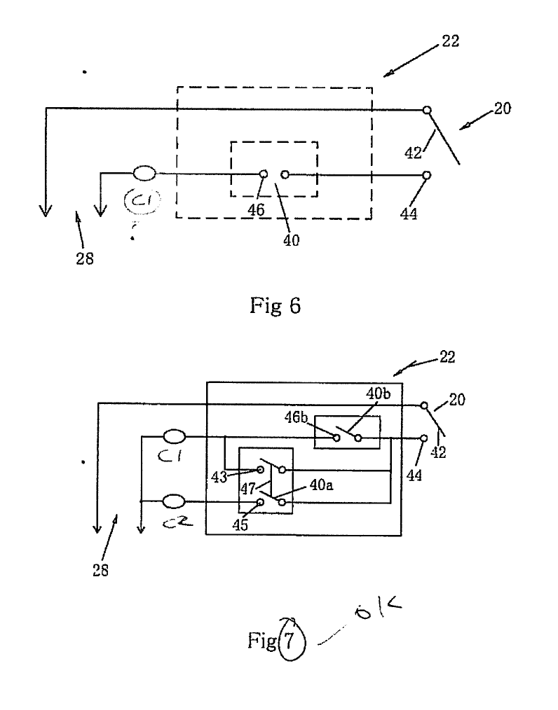

Typical circuitry for an electrical system is shown in FIGS. 6 and 7. FIG. 6 is for a single stage secondary switch and has one on/off position as shown at throw 40. The blast solenoid valve C1 actuates both air and media delivery. The power to the system is provided by connecting connector 28 to a typical power source, not shown. When the single throw 42 of the primary switch 20 is closed at 44 the power circuit is not completed unless secondary switch throw 40 is also closed at 46. Similarly, if secondary switch throw 40 is closed the circuit will not be completed unless primary switch throw 42 is also closed.

A multiple stage system is shown in FIG. 7. In this configuration the primary switch 20 operates as previously described. Specifically, throw 42 closes the circuit at 44. However, additional functions are provided by secondary switch 22. If the single element throw 40b is closed at 46b, only solenoid C1 will be actuated, delivering air only to the nozzle. When the double throw 40a of secondary switch 22 (shown diagrammatically tied together by link 47) is closed against pin 43 and 45, both solenoid C1 (for air delivery) and solenoid C2 (for media delivery) are closed.

In practice, switch element 40a occupies a portion of the secondary switch actuator and switch element 40b occupies a separate portion of the secondary switch actuator, as shown in FIG. 5, for example. The two switch segments may be separated by a suitable insulator 48.

Where desired, additional multiple functions may be controlled using this system. For example, it may be desirable to have multiple media systems such as coarse and fine to be delivered on demand in addition to the air system. It may also be desirable to color code the segments 40a and 40b, or otherwise label them, to make it clear which function is controlled by which switch segment.

This system provides an additional control mechanism for blasting systems without encumbering the operator in more than a minimum of change from prior art delivery systems. While certain features and embodiments of the invention have been described in detail herein, it should be understood that the invention encompasses all modifications and enhancements within the scope and spirit of the following claims.

1. A secondary back-up deadman switch for use in combination with a primary deadman switch having a circuit open and a circuit closed actuator for controlling the flow of an air/abrasive mix through a flow line of a delivery system, the secondary, back-up switch comprising a switch open/close element in series with the primary deadman switch actuator such that the controlled flow will not function unless both the primary deadman switch and the secondary back-up switch are closed.

2. The secondary back-up deadman switch of claim 1, wherein the switch further comprises a low-profile adapted to be mounted in axial alignment with the flow line in a manner to minimize interference with normal operation of the system.

3. The secondary back-up deadman switch of claim 1, wherein the switch further comprises multiple open/close elements, each element in series with the primary deadman switch actuator for selectively controlling different flow functions.

4. The secondary switch of claim 3, further including a series of segments forming a base for the secondary switch, wherein each element is mounted on a separate segment, the segments being mounted on the flow line in such a manner that the secondary switch assembly can bend during the normal course of use of the flow line.

5. The secondary back-up deadman switch of claim 3, including labels on each of the multiple open/close elements for defining the control function of each element.

6. The secondary back-up deadman switch of claim 5, wherein the labels are color coded.

7. The secondary back-up switch of claim 3, wherein one multiple element controls the flow of air through the system and another of said multiple elements controls the simultaneous flow of air and abrasive in a mix through the system.

8. The secondary back-up switch of claim 1, comprising:
a. At least one base element adapted to be placed directly on the flow conduit;
b. A conductor in the base element for completing a secondary switch circuit between the primary deadman switch and a power supply;
c. An interrupt switch for opening and closing the secondary switch circuit, wherein the circuit for controlling flow in the delivery system is not closed unless both the primary deadman switch actuator and the secondary switch interrupt switch are closed.

9. The secondary tack-up switch of claim 7, further comprising an end cap at an end of the base element for securing the interrupt switch in the assembly once the assembly is mounted on the flow line.

10. The secondary back-up switch of claim 7, wherein the base element has a contoured engagement surface conforming to the peripheral surface of the flow line.

11. The secondary back-up deadman switch of claim 8, wherein the switch further comprises multiple open/close elements, each element in series with the primary deadman switch actuator for selectively controlling different flow functions.

12. The secondary back-up switch of claim 10, wherein the base element has a through slot and there is also included a securement means adapted to be placed through the through slot and about the perimeter of the flow line for securing the base element to the flow line.

13. The secondary back-up switch of claim 10, wherein the securement means is an alligator tie.

14. A deadman switch having a circuit open and a circuit closed actuator for controlling the flow of an air/abrasive mix through a flow line of a delivery system, the switch comprising a switch open/close the controlled flow will not function unless the secondary back-up switch is closed, the switch further comprising a low-profile adapted to be mounted in axial alignment with the flow line in a manner to minimize interference with normal operation of the system.

15. The deadman switch of claim 12, wherein the switch further comprises multiple open/close elements, each element in series with the primary deadman switch actuator for selectively controlling different flow functions.

16. The deadman switch of claim 13, including labels on each of the multiple open/close elements for defining the control function of each element.

17. The deadman switch of claim 14, wherein the labels are color coded.

18. The deadman switch of claim 12, the deadman switch adapted for use in series combination with a second deadman switch such that the controlled flow cannot be actuated unless both the deadman switch and the second deadman switch are closed.

19. A secondary deadman switch for use in combination with a primary deadman switch with an opened and closed position, the secondary deadman switch having a circuit open and a circuit closed actuator for controlling the flow of an air/abrasive mix through a flow line of a delivery system, wherein the secondary deadman switch can be activated only when the primary deadman switch is closed, the switch comprising a switch open/close the controlled flow will not function unless the secondary back-up switch is closed, the switch further comprising a low-profile adapted to be mounted in axial alignment with the flow line in a manner to minimize interference with normal operation of the system.

20. The secondary deadman switch of claim 17, wherein the switch further comprises multiple open/close elements, each element in series with the primary deadman switch actuator for selectively controlling different flow functions.

21. The secondary deadman switch of claim 18, including labels on each of the multiple open/close elements for defining the control function of each element.

22. The secondary deadman switch of claim 19, wherein the labels are color coded.

23. The secondary deadman switch of claim 17, the secondary deadman switch adapted for use in series combination with a second deadman switch such that the controlled flow cannot be actuated unless both the deadman switch and the second deadman switch are closed.
